(19) United States
(12) Patent Application Publication
(10) Pub. No.: US 2002/0029319 A1
(43) Pub. Date: Mar. 7, 2002

(54) Logical unit mapping in a storage area network (SAN) environment

(76) Inventors: Robert Robbins, Sunnyvale, CA (US); Richard Meyer, San Francisco, CA (US); Jerry Smith, Long Beach, CA (US)

Correspondence Address: TOWNSEND AND TOWNSEND AND CREW, TWO EMBARCADERO CENTER, EIGHTH FLOOR, SAN FRANCISCO, CA, 94111-3834, US

(21) Appl. No.: 09/876,846

(22) Filed: Jun. 6, 2001

Related U.S. Application Data
(63) Continuation of application No. 09/369,057, filed on Aug. 4, 1999, now abandoned.
(60) Provisional application No. 60/108,461, filed on Nov. 14, 1998.

(51) Int. Cl. G06F 12/00

(52) U.S. Cl. 711/114; 711/156

(57) ABSTRACT

A system with a RAID controller connected to a plurality of hosts, and having a storage area configurable as a plurality of logical units. The RAID controller stores in an associated memory a table of access rights for the hosts to the logical units. Updates can be provided and additional material can be provided in new memory space that is subsequently made available to the various hosts by providing updated access rights that include the new space. In one embodiment, the present invention also maps the logical unit number from that requested by the host to an actual number used in the RAID subsystem.

### CROSS-REFERENCES TO RELATED APPLICATIONS

This application claims priority from U.S. provisional application no. 60/108,461 filed on Nov. 14, 1998 and having the same title. The contents of this provisional application are incorporated herein by reference.

### BACKGROUND OF THE INVENTION

The present invention relates to RAID (redundant array of independent disks) systems in a storage area network (SAN).

In one typical RAID configuration, a RAID controller is connected to an array of disk drives. The other side of the RAID controller connects to multiple hosts through an intermediate server. In a SAN environment, the intermediate server is eliminated, and the RAID controller is itself on the SAN network.

In such a network, a PC-NT host would typically try to take control of all memory spaces to which it is connected. In addition, if the RAID memory was to be used as the boot memory, multiple PCs would want to use the same logical unit (LUN) address for booting. It would be desirable to have a RAID controller which can connect into an SAN network and handle such operations transparent to the PCs on the network.

### SUMMARY OF THE INVENTION

The present invention provides a system with a RAID controller connected to a plurality of homogenous or heterogeneous hosts, and having a storage area configurable as a plurality of logical units. The RAID controller stores in an associated memory a table of access rights for the hosts to the logical units.

Preferably, a default setting is that a host does not have any access to the logical units of the RAID subsystem. An operator can then program the RAID controller to grant the desired amount of access to a particular host. Logical unit areas can be reserved to add new hosts, for instance. In addition, new space can be provided to existing hosts dynamically without affecting operations in logical unit space already accessible by the particular host. Updates can be provided and additional material can be provided in new memory space that is subsequently made available to the various hosts by providing updated access rights that include the new space.

In one embodiment, the present invention also maps the logical unit number from that requested by the host to an actual number used in the RAID subsystem. For example, multiple hosts may request logical unit number zero (LUN0), and other than the first host, they may be mapped to a different logical unit, such as LUN5, LUN8, etc.

For a further understanding of the nature and advantages of the invention, reference should be made to the following description taken in conjunction with the accompanying drawings.

### BRIEF DESCRIPTION OF THE DRAWINGS

FIG. 1 is a block diagram of a SAN network including a RAID controller according to the invention.

FIG. 2 is a flowchart illustrating the checking of access rights.

FIG. 3 is a block diagram illustrating two redundant RAID controllers.

### DESCRIPTION OF THE SPECIFIC EMBODIMENTS

The invention allows the RAID controller user to allocate access to the storage area at the RAID subsystem level. Thus, a PC-NT host which will want to take control of everything it is connected to will only know about a designated portion of the memory space. The invention is particularly advantageous for a fast fibre optic network. In particular, previous network systems typically had a dedicated server that would control access to the memory substem. With faster links, this limits the access speed, and the present invention allows the elimination of this intermediate server.

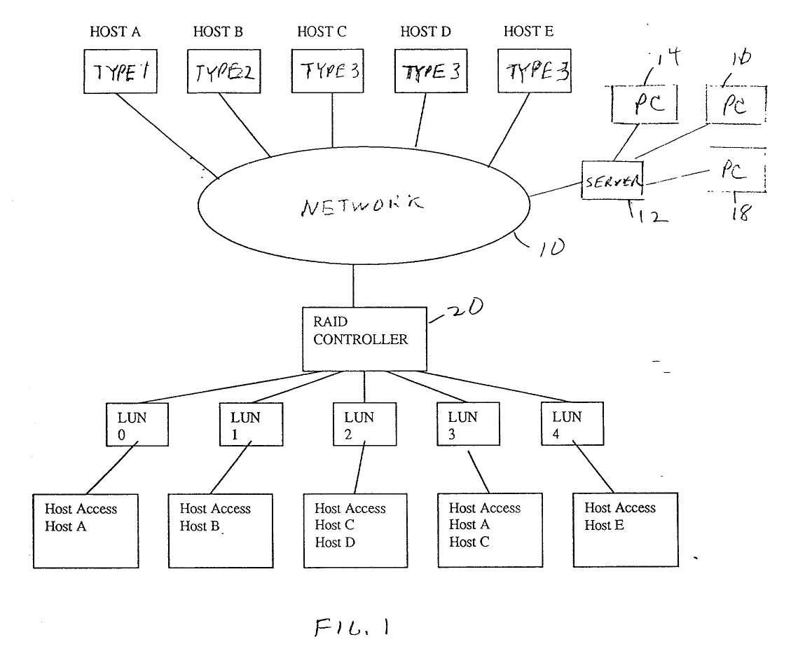

FIG. 1 shows a network 10 connected to a number of host computers A-E. Also shown is a separate server 12, which may itself be connected to a number of separate hosts 14, 16, and 18. A RAID controller 20 is also connected to the network.

RAID controller 20 is shown as accessing multiple logical unit numbers 0-4. Illustrated below each logical unit number is an example of which hosts are granted access to that LUN.

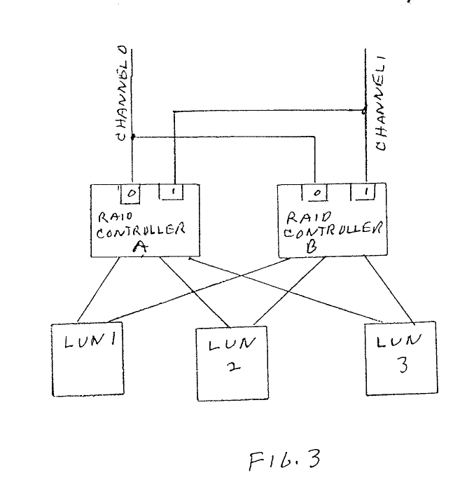

The network in FIG. 1 is preferably a fibre network, but could be any other type of network or any switching or shared bus. For example, it could be a SCSI bus. The RAID controller of FIG. I is shown at a logical level, and could be two redundant RAID controllers as shown in FIG. 3. Each RAID controller can be connected to two channels to the host, channels 0 and 1.

RAID controllers must be able to supply common shared storage in both a heterogeneous and homogeneous networked environment without additional software required on the host systems to manage access to the units. The RAID controller must be able to partition the storage into logical units that can be presented to the hosts. This logical unit is a grouping of memory storage for which there is some method for mapping the access known by the RAID controller. It is independent of the actual physical storage media being used. For the RAID controller to provide the common storage in a SAN environment, it must be capable of limiting access to the logical units on a host by host basis.

The RAID controller software provides a method for controlling the access of the logical units on a host by host basis. It provides the user the capability of managing the logical units and limiting access. The user enters in the unique name or identifier for a specific host that can be obtained by the RAID controller on the network. The user then selects which logical units that host can be allowed to access. This information is maintained in a table in the controller's memory when the code is running, allowing the changes to be implemented dynamically. It is also saved in some form of memory storage (flash, EEPROM, NVRAM, disk, etc.) so that it is persistent across reboots, power failures, etc. A copy is also sent to all of the controller's failover partners in a redundant configuration to maintain access across failures.

The controller software allows the logical units to be accessible to any combination of hosts. The user can enable access by none, one, or any number of hosts as required. Because the controller manages the storage and access to it, the hosts on the SAN do not need to communicate with each other, or even know other hosts are on the network.

In addition to controlling whether or not the logical unit is accessible by a host, the user can also limit the host access to the logical unit to read only. This allows the user to set up the logical unit as shared by several selected hosts and specify which of those hosts can update the data and which can only view the data.

When the controller receives a request from a host for a logical unit, it checks the access table to determine if the host is allowed access. If the host is not allowed access, the controller reports back to the host that the logical unit is not connected. If the host is allowed access, the request is processed.

The user can access the RAID controller for configuration, etc., through a serial port connected to a terminal (console) or PC. Alternately, a PC connected through an Ethernet network could be used, or any other access method.

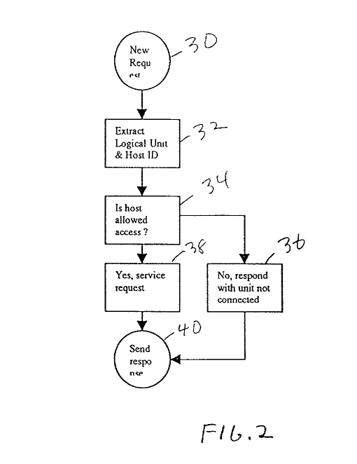

The flowchart of FIG. 2 illustrates how a host request 30 for access to the storage space is handled. The RAID controller first extracts from the host request the logical unit the host is trying to access and the host ID (step 32). The logical unit requested is compared to a table to determine if the host will be granted access rights (step 34).

If no access rights are provided, a response is sent to the host request indicating that the logical unit requested is not connected (step 36). If access is allowed, the request is serviced (step 38). A response is sent back to the host in either case (step 40).

The invention provides a high degree of configuration flexibility. For example, a user can configure the system to tell a particular host that there is not any logical unit available, fooling the host into thinking it is simply not connected. If multiple hosts are sharing a common storage, they can be granted the same access rights. The storage can be added to in an area where no access is provided, and then after the additions have been checked, access rights to the new storage can be dynamically added. Similarly, a portion can be dynamically removed from the access rights, modified, then access can be provided again. In addition to dynamically bringing storage in and out, hosts can be dynamically brought in and out by eliminating and adding access rights dynamically.

SAN volume mapping to specific host systems can be used to isolate storage to specific hosts systems for performance, management, and data protection.

Zones or host mappings support functions and business needs similar to how a traditional network can be subdivided into sub-nets. Performance, data protection, security, fire-walling, and different application requirements will drive zoning and host to LUN mapping.

Zoning can be accomplished via switches as well as via RAID devices using either port to port mappings, or LUN to World Wide Port Name mapping.

The present invention thus provides the ability to dynamically modify LUN access on the fly. Typically, this may be done to add access and expand storage without rebooting. Where a mirrored set is provided, both are written to.

The present invention can also provide limited access to a LUN, as opposed to total or no access. For example, read only access could be provided. This would be useful, for instance, to allow another host to do backup at the same time that a LUN is also accessible by other hosts. The backup server would be given read only access, and thus there is less chance of conflicts with other hosts attempting to read and write the same area. By granting a backup server read only access for backing up, it need only be given the access during the backup time and thus the backup server doesn't have to have access to the same memory all the time. This eliminates the need to use one of the hosts using the storage for backup purposes.

In addition, where a RAID server is used for an internet company, read only access could be provided. Another portion of the memory could be reserved for writing updates, which could then be subsequently provided to users by updating their access rights.

A customer can communicate with the RAID controller through a console connected to it or through a GUI interface from host. Both are preferably password protected.

The 6300 and 6700 both connect to hosts over a fibre channel interface. The 6300 described below is an example RAID controller using SCSI interfaces to a RAID array of disk drives that form the LUNs. The user manuals for the 6300 and 6700 describe the operation in more detail, and are available from MTI Technology Corp. The 6300 has a default condition where all hosts have total access. The 6700 is a RAID controller using fibre interfaces to the RAID disk drives. The 6700 has a default condition where no host has access. Any default condition could be used for any system configuration.

The port names set forth conform to IEEE standard 802-1990 for naming.

Configuring LUN Affinity

The RAID controllers support defining which hosts on the Fibre Channel Arbitrated Loop have access to which LUNs. Each LUN can be set up to be accessed by any number of hosts. The hosts are defined by their worldwide unique port name. On the 6700 no host has access to any LUN unless there is an entry in the table. On the 6300 all hosts have access to all LUNs if no table exists. Currently this access must be set up through the serial console port. On the 6700 the changes will have effect the next time the host attempts to access a LUN that has been changed.

6700 Host Access Table

| | |
|---|---|
| 1. | At the serial console port, type gladMenu to the main menu. |
| 2. | Select 1 to get to the Field Service menu. |
| 3. | Select 1 to get to the Configuration menu. |
| 4. | Select 6 to display the Host Access Table. |
| 5. | Select 7 to edit the Host Access Table. |
| 6. | Enter P to add or delete a host, or L to edit the LUN access for a |
| | host already in the table, at the prompt. If you select L, go to |
| | step 9. |
| 7. | If you selected P, enter D to delete a host, or A to add a host, at |
| | the prompt. |
| 8. | Select either channel 0 or 1 at the prompt, based upon which port |
| | the LUN is assigned to. |
| 9. | Enter the 8 byte worldwide unique name of the host. |
| 10. | Enter a 12 byte text description to identify the host. |
| 11. | For each LUN displayed as disabled that you want to enable type t. |

Sample Host Access Entry Display:
Enter channel (0 or 1): 0
Hosts currently logged in:

20:00:00:e0:8b:00:72:03

Port name: 20:00:00:e0:8b:00:72:03
Host name: System One
LUN 0 is enabled
LUN 1 is disabled
LUN 2 is enabled
LUN 3 is disabled
LUN 4 is disabled

6300 Host Access Table

| | |
|---|---|
| 1. | At the serial console port, type gladMenu to get to the main menu. |
| 2. | Select 1 to get to the Field Service menu. |
| 3. | Select 7 to get to the FC LUN MAP menu. |
| 4. | If you need the port information for the nodes on the FCAL, select |
| | 5 to display the logged-in hosts. |
| 5. | Select 1 to display the LUN map. |
| 6. | Select 2 to remove a host from the LUN map. |
| 7. | Select 3 to add a host to the LUN map. |
| 8. | After making changes, select 4 to save LUN map. |
| 9. | Select 6 to remove the LUN map to start from scratch. |
| | WARNING: All the data in the LUN MAP file will be destroyed. |
| 10. | Select 7 to get a copy of partner board's LUN MAP onto this |
| | board. |

Sample Logged In Hosts Display:
Host Map
ALPA Node Name

| | |
|---|---|
| 1 | 100000a0f1000132 |
| 2 | 100000b2a0001094 |
| ef | 10000098bf221032 |

Sample LUN MAP Display:
LUN Map

| ALPA | Host LUN | RAID LUN |
|---|---|---|
| 1 | 0 | 0 |
| 1 | 1 | 1 |
| 1 | 2 | 2 |
| 1 | 3 | 3 |
| 2 | 0 | 0 |
| ef | 0 | 0 |
| ef | 1 | 4 |
| ef | 2 | 5 |
| ef | 3 | 6 |

RAID LUN is the actual LUN number assigned in the 6300 array. Host LUN is the LUN number that is presented to the host for that RAID LUN.

As will be understood by those of skill in the art, the present invention may be embodied in other specific forms without departing from the essential characteristics thereof. Accordingly, the foregoing description is intended to be illustrative, but not limiting, of the scope of the invention which is set forth in the following claims.

What is claimed is:

1. A memory storage system comprising:
a RAID controller configured to connect to a plurality of hosts;
a storage area configurable as a plurality of logical units; and
a memory, connected to said RAID controller, for storing access rights of said hosts to said logical units.

2. The system of claim 1 wherein said RAID controller is configured to dynamically change said access rights in said memory.

3. The system of claim 1 wherein said memory stores default access rights granting no access.

4. The system of claim 1 further comprising a fibre channel network connecting said memory storage system to said plurality of hosts.

5. The system of claim 1 wherein said memory further stores a remapping of logical units, so that multiple hosts can access said memory storage system specifying an identical logical unit, and be directed to different logical units.

6. The system of claim I wherein a grouping of memory storage corresponding to logical units assigned to a particular host is transparent to said particular host.

7. The system of claim 1 further comprising a table in said memory, said table storing both said access rights and a mapping to translated logical units.

8. A memory storage system comprising:
a RAID controller configured to connect to a plurality of hosts;
a storage area configurable as a plurality of logical units; and
a memory, connected to said RAID controller, for storing access rights of said hosts to said logical units;
said RAID controller being configured to dynamically change said access rights in said memory;
said memory storing default access rights granting no access; and
said memory further storing a remapping of logical units, so that multiple hosts can access said memory storage system specifying an identical logical unit, and be directed to different logical units.

9. The system of claim 8 further comprising a fibre channel network connecting said memory storage system to said plurality of hosts.

10. A method for operating a memory storage system comprising:
connecting a RAID controller to a plurality of hosts;
said RAID controller being connected to a storage area configurable as a plurality of logical units; and
storing access rights of said hosts to said logical units.

11. The method of claim 10 further comprising dynamically altering said access rights.

12. The method of claim 11 wherein said dynamically altering comprises adding access rights to a particular host without affecting existing access rights of said particular host.

13. The method of claim 10 further comprising storing a default of no access rights prior to granting access rights to a host.

14. The method of claim 10 further comprising reserving a designated plurality of logical units for future hosts to be added, and not granting existing hosts access to said designated plurality of logical units.

15. A method for operating a memory storage system comprising:
connecting a RAID controller to a plurality of hosts;
said RAID controller being connected to a storage area configurable as a plurality of logical units;
storing access rights of said hosts to said logical units;
dynamically altering said access rights, wherein said dynamically altering comprises adding access rights to a particular host without affecting existing access rights of said particular host; and
storing a default of no access rights prior to granting access rights to a host.

16. The method of claim 15 further comprising reserving a designated plurality of logical units for future hosts to be added, and not granting existing hosts access to said designated plurality of logical units.
